(19) United States
(12) Patent Application Publication
(10) Pub. No.: US 2025/0141081 A1
(43) Pub. Date: May 1, 2025

(54) Directional coupler having a compact layout configuration

(71) Applicant: RichWave Technology Corp., Taipei City (TW)

(72) Inventors: Chang-Yi Chen, Taipei City (TW); Chih-Sheng Chen, Taipei City (TW)

(73) Assignee: RichWave Technology Corp., Taipei City (TW)

(21) Appl. No.: 18/914,237

(22) Filed: Oct. 13, 2024

Related U.S. Application Data
(60) Provisional application No. 63/594,415, filed on Oct. 30, 2023.

(30) Foreign Application Priority Data
Sep. 25, 2024 (TW) 113136418

(51) Int. Cl. H01P 5/18

(52) U.S. Cl. CPC H01P 5/18

(57) ABSTRACT

A directional coupler includes a main path, a coupling path, a first port, and a second port. The main path is used to propagate a first RF signal. The coupling path at least partially overlaps with the main path. The coupling path includes a first end, a second end, and at least one winding routed between the first end and the second end. The first port is coupled to the first end of the coupling path. The second port is coupled to the second end of the coupling path. At least one of the first port and the second port is located inside the at least one winding.

### CROSS REFERENCE TO RELATED APPLICATION

This application claims the benefits of U.S. Provisional Application No. 63/594,415, filed on Oct. 30, 2023, and Taiwan patent application No. 113136418, filed on Sep. 25, 2024. The content of these applications is incorporated herein by reference.

### TECHNICAL FIELD

The present invention relates to a radio frequency (RF) circuit, and more specifically, to a directional coupler.

### BACKGROUND

A directional coupler is a passive device used to couple a portion of the electromagnetic power in a signal path to another path, thereby generating a new RF signal that may be used for power detection or control. A directional coupler may typically include two paths: a transmission path and a coupling path. These two paths are placed close enough to each other to allow power to be transferred from one path to the other, for example, from the transmission path to the coupling path.

When designing a directional coupler, a compact layout and reduced insertion loss may be key considerations. For instance, a compact layout may require the transmission path and the coupling path to have a small area, which may lead to a limited area for both paths, potentially resulting in an insufficient coupling factor.

The coupling factor, also known as the coupling coefficient, is measured in decibels (dB) and is used to indicate the strong or weak coupling between the two paths of the coupler. It may be determined by the amount of power transferred from one path to the other. The coupling factor may be significantly influenced by at least one of the followings: the size and/or shape of the transmission path, the size and/or shape of the coupling path, and the appropriate proximity of the two paths. In other words, the coupling factor may be determined by the electromagnetic interaction between the two paths. In a compact layout, there may not be enough area for the transmission path, leading to a shortened transmission path or a reduced number of turns in the transmission path, which may be detrimental for a desired coupling factor. For example, the transmission path may be designed as a straight line without any turns.

A shortened transmission path or a reduced number of turns in the transmission path may result in a weaken interaction between the transmission path and the coupling path, thereby reducing the coupling factor. This is because the generated magnetic field may be weaker, resulting in lower induced current or induced voltage from the coupling. Therefore, careful consideration may be required when designing a directional coupler.

### SUMMARY

An embodiment of the present invention provides a directional coupler. The directional coupler may comprise a main path, a coupling path, a first port, and a second port. The main path is used to transmit a first radio frequency (RF) signal. The coupling path at least partially overlaps with the main path. The coupling path may comprise a first end, a second end, and at least one winding routed between the first end and the second end. The first port is coupled to the first end of the coupling path. The second port is coupled to the second end of the coupling path. At least one of the first port and the second port is located inside the at least one winding.

Another embodiment of the present invention provides a directional coupler. The directional coupler may comprise a main path, a coupling path, a first port, a second port, and at least one passive component. The main path is used to transmit a first radio frequency (RF) signal. The coupling path at least partially overlaps with the main path. The coupling path may comprise a first end, a second end, and at least one winding routed between the first end and the second end. The at least one winding may comprise an innermost winding, which may comprise a first section and a second section. The first section is closer to the main path than the second section, and the first section is parallel to the main path. The first port is coupled to the first end of the coupling path. The second port is coupled to the second end of the coupling path. The at least one passive component is located at the first section of the innermost winding.

### BRIEF DESCRIPTION OF THE DRAWINGS

FIG. 1 is a top view of the layout of a directional coupler according to an embodiment of the present invention.

FIG. 2 is a cross-sectional view of the directional coupler in FIG. 1 along the dashed line 2-2′.

FIG. 3 is a cross-sectional view of the directional coupler in FIG. 1 along the dashed line 3-3′.

FIG. 4 is a top view of the layout of a directional coupler according to another embodiment of the present invention.

FIG. 5 is a top view of the layout of a directional coupler according to another embodiment of the present invention.

### DETAILED DESCRIPTION

Below, exemplary embodiments will be described in detail with reference to accompanying drawings so as to be easily appreciated by a person having ordinary knowledge in the art. The inventive concept may be embodied in various forms without being limited to the exemplary embodiments set forth herein. Descriptions of well-known parts may be omitted for clarity, and like reference numerals refer to like elements throughout.

The present invention may be understood by referring to the following detailed description in conjunction with the accompanying drawings. It should be noted that, for the sake of clarity and simplicity, the drawings in the present invention may only depict a part of the electronic device, and the specific elements in the drawings may not be drawn to scale. Additionally, the quantity and size of the elements in the drawings are merely illustrative and are not intended to limit the scope of the present invention. In the drawings, elements marked with the same symbols may have the same or similar attributes or functions throughout the context.

Certain terms are used in the specification and the appended claims to refer to specific elements. It should be understood by those skilled in the art that manufacturers of electronic devices may refer to the same elements by different names. This document is not intended to distinguish between elements that perform the same function but are named differently.

In the following specification and claims, the terms “comprising,” “including,” and “having” are open-ended terms, and therefore should be interpreted as “including but not limited to.” Thus, when the description of the present invention uses the terms “comprising,” “including,” and/or “having,” it specifies the presence of corresponding features, regions, steps, operations, and/or components, but does not exclude the presence of other features, regions, steps, operations, and/or components.

Directional terms mentioned herein, such as “inner,” “outer,” “upper,” “lower,” “front,” “rear,” “left,” “right,” etc., may merely references to the directions in the drawings. Therefore, the directional terms are used for explanation and not to limit the present invention. In the drawings, the depicted methods, structures, and/or materials are typical features used in specific embodiments. However, these drawings should not be construed as defining or limiting the scope or nature of the embodiments covered. For example, for clarity, the relative sizes, thicknesses, and positions of various layers, regions, and/or structures may be reduced or enlarged.

It should be noted that the following embodiments may be replaced, reorganized, and combined with features from different embodiments without departing from the spirit of the present invention to complete other embodiments. The features of the embodiments may be mixed and matched as long as they do not contradict or conflict with the spirit of the invention.

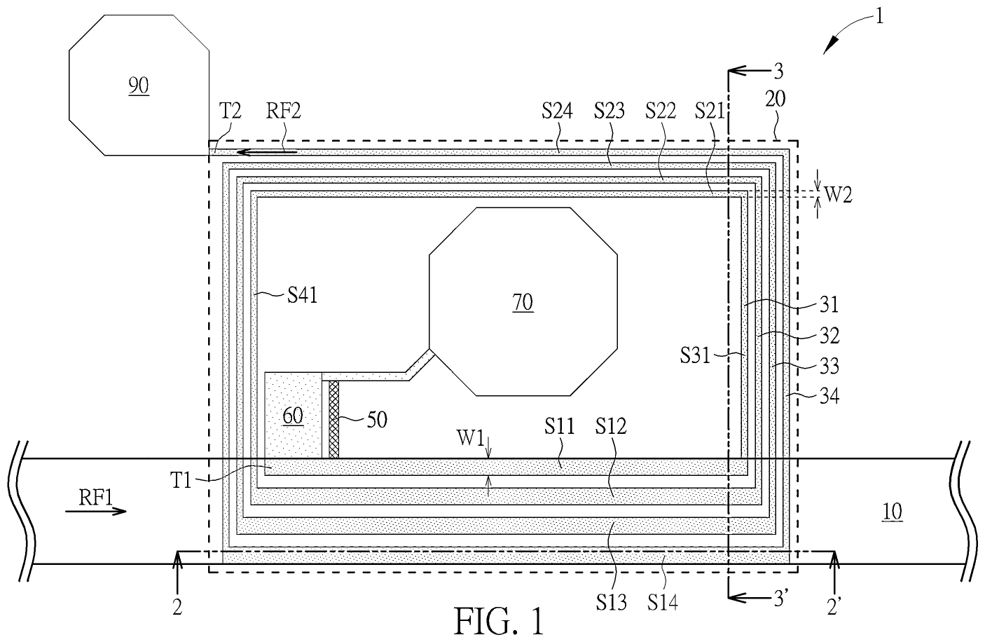

Please refer to FIG. 1. FIG. 1 is a top view of the layout of a directional coupler 1 according to an embodiment of the present invention. In some embodiments, the directional coupler 1 may be placed between an amplifier and an antenna, and may be used to monitor and measure the power of the radio frequency (RF) signal, and further to adjust the output power of the RF signal based on the measurement results. Furthermore, the directional coupler 1 may be further coupled to a power detector, which may receive the coupled signal from the directional coupler 1 and output a detection signal accordingly.

In some embodiments, as shown in FIG. 1, the directional coupler 1 may comprise a main path 10, a coupling path 20, and at least one port. For example, the at least one port may comprise a port 70 and a port 90.

The main path 10 may be configured to transmit (e.g., send and/or receive) a first radio frequency (RF) signal RF1. The first RF signal RF1, for example, may be a signal transmitted from the output of an amplifier to an antenna. Furthermore, the main path 10 may be placed between two ports, such as an input port and an output port. In this case, the input port of the main path 10 may be coupled to the output of the amplifier, and the output port of the main path 10 may be coupled to the antenna. Thus, the first RF signal RF1 from the amplifier may be transmitted from the input port to the output port of the main path 10, and further transmitted to the antenna.

The coupling path 20 may be configured to generate a second

RF signal RF2 through the electromagnetic coupling with the main path 10, for example, by coupling a certain amount of power from the first RF signal RF1 based on a coupling factor, thereby generating the second RF signal RF2. In some embodiments, in the top view of the directional coupler 1, that is, when viewed from a top direction of the directional coupler 1, the coupling path 20 may at least partially overlap with the main path 10. As shown in FIG. 1, the coupling path 20 may comprise a first end T1, a second end T2, and at least one winding, and the at least one winding is routed between the first end T1 and the second end T2. Specifically, the at least one winding may comprise four windings 31, 32, 33, and 34. The winding 31 may be the innermost winding, and the winding 34 may be the outermost winding. However, the present invention is not limited thereto. In other embodiments, the number of windings may be two, three, five, and so on.

It is noted that the windings described herein may comprise a plurality of sections, with at least two sections having an angle therebetween, that is, the angle between the tangents of the at least two sections is an acute angle, an obtuse angle, or a right angle. In other words, the winding may comprise at least two sections, and the angle between the tangents of the two sections is not zero or 180 degrees.

Furthermore, the coupling path 20 may be placed between two ports, such as the port 70 and the port 90. In this embodiment, the port 70 may be coupled to the first end T1 of the coupling path 20, and the port 90 may be coupled to the second end T2 of the coupling path 20.

In one embodiment of the present invention, at least one of the port 70 and the port 90 may be located inside the winding(s) of the coupling path 20. For example, the port 70 may be located inside at least one winding, specifically, the port 70 may be located inside the innermost winding 31. Therefore, the port 70 may be referred to as an inner port. In other words, the windings 31 to 34 of the coupling path 20 may surround the port 70. The port 90 may be located outside the at least one winding, specifically, the port 90 may be located outside the outermost winding 34. Therefore, the port 90 may be referred to as an outer port. In the embodiment, the first end T1 of the coupling path 20 coupled to the port 70 may be located inside the winding(s), and the second end T2 coupled to the port 90 may be located outside the winding.

In one embodiment of the present invention, at least one winding of the coupling path 20 may have a substantially rectangular outline. As shown in FIG. 1, the port 90 is shown at the upper left corner outside the rectangle, but the present invention is not limited thereto. In other embodiments, the port 90 may be located at other positions outside the rectangle, such as the upper right corner. In some embodiments, the port 90 may be directly coupled to the second section S24 of the outermost winding 34. That is, the port 90 may be located at the second section S24 of the outermost winding 34.

In this embodiment, the footprint of the coupling path 20 may have a first dimension of approximately 237 μm and a second dimension of approximately 180 μm.

As shown in FIG. 1, the port 70 is shown substantially at the center of the rectangle, but the present invention is not limited thereto. In other embodiments, the port 70 may be located at other positions relative to the rectangle, such as the left side position or the right side position. The first end T1 of the coupling path 20 is shown as the end of the first section S11 of the innermost winding 31, which is shown at the left side position of the rectangle in FIG. 1, but the present invention is not limited thereto. In other embodiments, the first end T1 may be located at other positions of the rectangle, such as the center or the right side position.

For example, the port 70 or the port 90 may be a coupled port or an isolation port. In one embodiment of the present invention, the port 90 may be used as a coupled port to output the second RF signal RF2. The port 70 may be used as an isolation port, such as being grounded. Therefore, the port 70 may also be referred to as a grounded port. Ideally, there is no signal output at the port 70, that is, the power of the signal may be zero. However, in practical applications, due to a certain degree of mismatch in the circuit, there may be a low-power signal at the port 70. Furthermore, the port 70 may be further coupled to other circuits (e.g., a resistor) to adjust the extent of mismatch of the circuit.

It is noted that the functions of the various ports described above are for illustrative purposes only and are not intended to limit their use. That is, for example, the port 90 of the directional coupler 1 may also be used as an isolation port, and the port 70 may also be used as a coupled port. The coupled port may also be referred to as a detection port. For example, the port 70 and/or the port 90 may comprise a pad, a through-wafer via, or a through silicon via. Additionally, the port 70 and/or the port 90 may be further coupled to a bonding wire, a bump, or a grounded terminal.

As shown in FIG. 1, in a top view of the directional coupler 1, taking the innermost winding 31 as an example, it may include a first section S11, a second section S21, and other sections (e.g., a third section S31 and a fourth section S41) connected between the first section S11 and the second section S21. The first section S11 and the second section S21 may be parallel to the main path 10, and the first section S11 may be closer to the main path 10 than the second section S21. The third section S31 and the fourth section S41 may be perpendicular to the main path 10. Furthermore, the first section S11 may overlap with the main path 10, while the second section S21 may not overlap with the main path 10.

In further embodiments, the first section S11 may have a width W1, the second section S21 may have a width W2, and the width W1 may not be equal to the width W2. Preferably, the width W1 may be greater than the width W2. In this embodiment, for the innermost winding 31, electromagnetic coupling may substantially occur between the main path 10 and the first section S11.

Similarly, the winding 32 may comprise a first section S12, a second section S22, and other sections connected between the first section S12 and the second section S22. The winding 33 may comprise a first section S13, a second section S23, and other sections connected between the first section S13 and the second section S23. The outermost winding 34 may comprise a first section S14, a second section S24, and other sections connected between the first section S14 and the second section S24.

In one embodiment of the present invention, the main path 10 may be formed in a first layer L1, and the coupling path 20 may be formed in a second layer L2 different from the first layer L1.

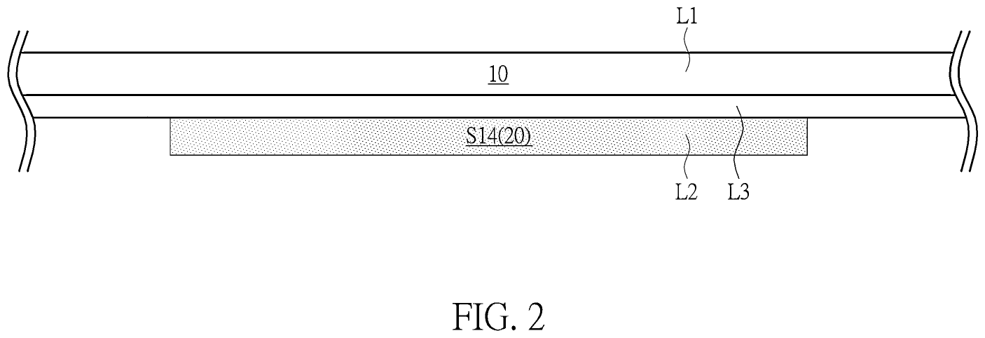

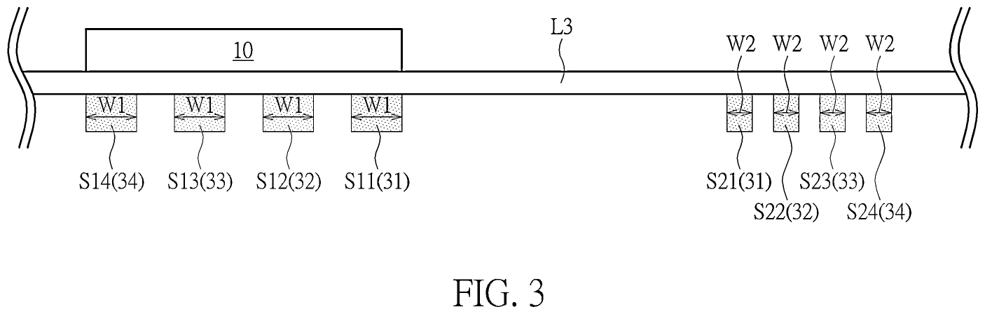

Please refer to FIG. 2 and FIG. 3. FIG. 2 is a cross-sectional view of the directional coupler 1 in FIG. 1 along the dashed line 2-2′. FIG. 3 is a cross-sectional view of the directional coupler 1 in FIG. 1 along the dashed line 3-3′.

As shown in FIG. 2, the main path 10 may be formed in the first layer L1, for example, the main path 10 may be a conductive path located in the first layer L1. The coupling path 20 (shown as the first section S14 of the outermost winding 34 in FIG. 2) may be formed in the second layer L2, and for example, the coupling path 20 may be a conductive path located in the second layer L2. Additionally, an insulating layer L3 may be formed between the first layer L1 and the second layer L2. For example, the conductive material of the main path 10 or the coupling path 20 may include, but is not limited to, aluminum, copper, gold, silver, and their combinations or alloys. The material of the insulating layer L3 may include, but is not limited to, silicon dioxide (SiO₂), silicon nitride (SiNₓ), hafnium oxide (HfO₂), zirconium oxide (ZrO₂), and/or tantalum pentoxide (Ta₂O₅).

As shown in FIG. 3, the first section S11 of the innermost winding 31, the first section S12 of the winding 32, the first section S13 of the winding 33, and the first section S14 of the outermost winding 34 all overlap with the main path 10. However, the present invention is not limited thereto. In other embodiments, for example, the first section S11 of the innermost winding 31 or the first section S14 of the outermost winding 34 may not overlap with the main path 10. Furthermore, the second section S21 of the innermost winding 31, the second section S22 of the winding 32, the second section S23 of the winding 33, and the second section S24 of the outermost winding 34 do not overlap with the main path 10. However, the present invention is not limited thereto. In other embodiments, for example, the second section S21 of the innermost winding 31 may overlap with the main path 10.

In the embodiment, the widths of the first sections S11, S12, S13, and S14 are the same, for example, all being a width W1. The widths of the second sections S21, S22, S23, and S24 are the same, for example, all being a width W2. However, in other embodiments, the widths of the first sections S11, S12, S13, and S14 may be different, and/or the widths of the second sections S21, S22, S23, and S24 may be different.

Traditionally, both the coupled port and the isolated port of a coupler may be located outside of the winding, so crossing paths may be required to connect the inner end (e.g., the first end) of the winding to the port located outside the winding. In this case, undesired electromagnetic coupling may occur between the crossing paths and the windings of the coupling path. In at least one embodiment of the present invention, at least one of the ports 70 and 90 may be located inside the winding(s) of the coupling path 20. For example, the port 70, which may serve as an isolation port, may be located inside the winding(s), thereby avoiding crossing paths and reducing or avoiding undesired electromagnetic coupling. Furthermore, the directional coupler according to at least one embodiment of the present invention may utilize the layout area more effectively, thereby achieving a compact layout configuration.

In at least one embodiment of the present invention, for example, the coupling factor may be determined or adjusted by the overlapping area between the coupling path 20 and the main path 10.

In one embodiment, the coupling factor may be adjusted by changing the extent of overlap between the first section of at least one winding and the main path. For example, the first section S11 of the innermost winding 31 may completely overlap, partially overlap, or not overlap with the main path 10, thereby achieving different coupling factors. For example, in the case of complete overlap between the first section S11 and the main path 10, a larger coupling factor may be achieved. In the case of no overlap between the first section S11 and the main path 10, a smaller coupling factor may be achieved. Similarly, the first section S14 of the outermost winding 34 may completely overlap, partially overlap, or not overlap with the main path 10, thereby achieving different coupling factors.

In another embodiment, the coupling factor may be adjusted by changing the width of the first section of at least one winding. For example, the first section S11 of the innermost winding 31 may be widened, thereby achieving a larger coupling factor.

In yet another embodiment, the coupling factor may be adjusted by changing the number of the at least one windings. For example, more windings may generate a larger coupling factor.

According to at least one embodiment of the present invention, a larger coupling factor may still be achieved even when the layout area available for the directional coupler 1 is limited. For example, a desired coupling factor may be achieved even when the main path 10 is a single straight path with a shorter length. Therefore, at least one embodiment of the present invention may provide a directional coupler with a desired coupling factor, lower insertion loss, and/or a compact layout.

Referring back to FIG. 1, in some embodiments, the directional coupler 1 may further include at least one passive component, which may be coupled between the coupling path 20 and the inner port 70. The at least one passive component may include a resistor 50 and/or a capacitor 60. Specifically, the first end of the resistor 50 may be directly coupled to the first section S11 of the innermost winding 31 of the coupling path 20, that is, located at the first section S11 of the innermost winding 31. The second end of the resistor 50 may be coupled to the inner port 70. Similarly, the first end of the capacitor 60 may be directly coupled to the first section S11 of the innermost winding 31, that is, located at the first section S11 of the innermost winding 31. The second end of the capacitor 60 may be coupled to the inner port 70. In this embodiment, the resistor 50 and the capacitor 60 may be connected in parallel and may be located at different positions of the first section S11 of the innermost winding 31.

In this embodiment, the resistor 50 and the capacitor 60 may be configured for an RC circuit. The RC circuit may be used to achieve impedance matching between the directional coupler 1 and a circuit to which the directional coupler 1 is coupled, resulting in reduced reflection thereby achieving desired isolation between various ports and/or improving the performance of the directional coupler 1. In addition, the RC circuit may be used to filter out unwanted signals (such as noise or interference). This may improve the quality of the signal coupled to the port 90 of the directional coupler 1 (e.g., the second radio frequency signal RF2).

In other embodiments of the present invention, the coupling path 20 of the directional coupler 1 may have other polygonal outlines.

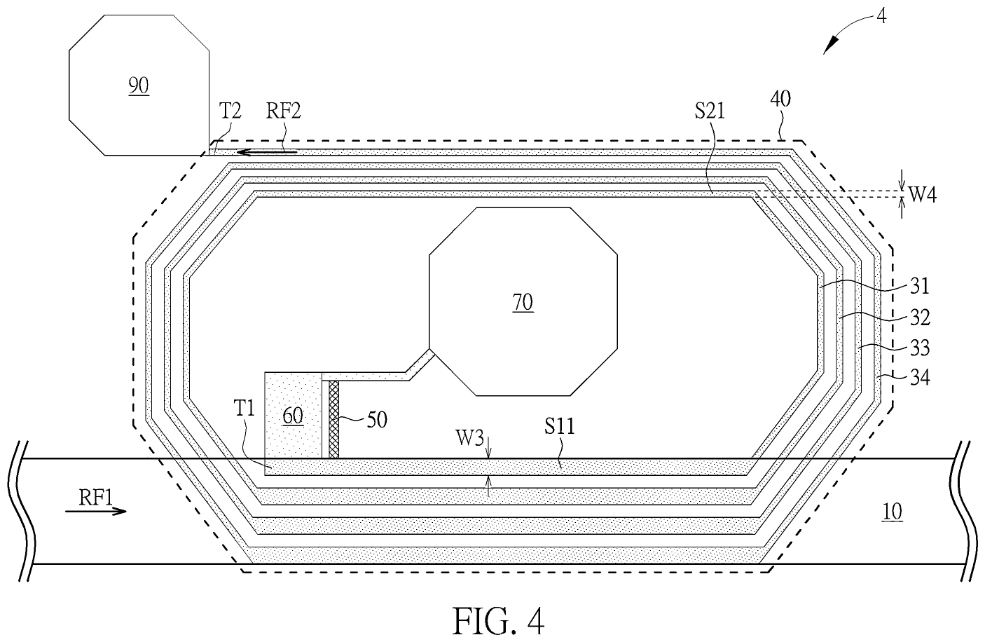

Referring to FIG. 4, FIG. 4 is a top view of the layout of the directional coupler 4 according to another embodiment of the present invention. The directional coupler 4 may comprise the main path 10, a coupling path 40, the port 70, and the port 90. The difference between the directional coupler 4 and the directional coupler 1 lies in the outline of the coupling path 40 and that of the coupling path 20. The coupling path 40 may have an octagonal outline. Specifically, the coupling path 40 may comprise a first end T1 coupled to the port 70, a second end T2 coupled to the port 90, and at least one winding routed between the first end T1 and the second end T2. Similarly, taking the innermost winding 31 as an example, the first section S11 may have a width W3, the second section S21 may have a width W4, and the width W3 may not be equal to the width W4.

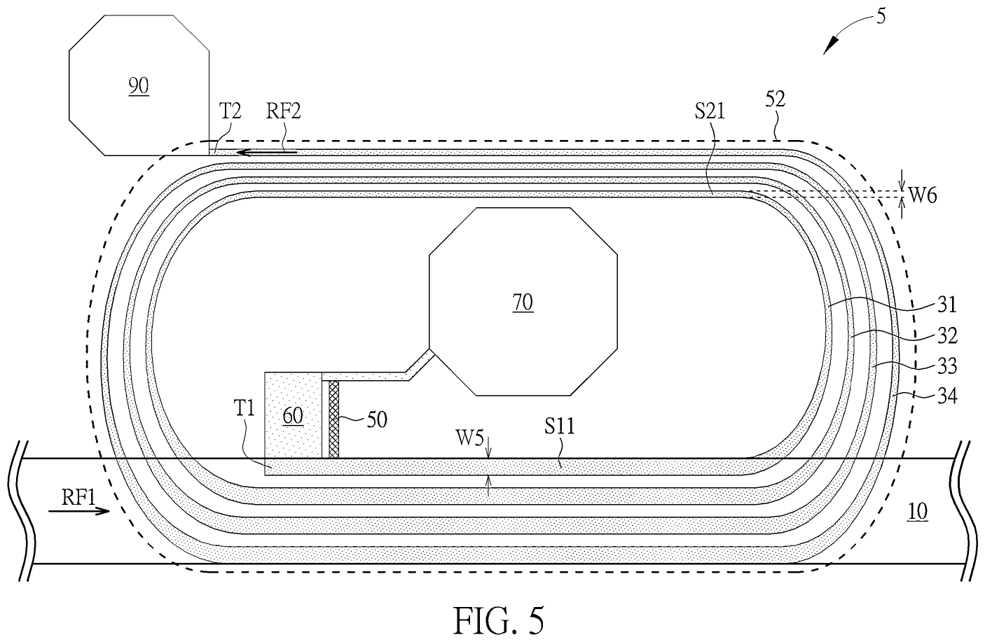

Referring to FIG. 5, FIG. 5 is a top view of the layout of the directional coupler 5 according to another embodiment of the present invention. The directional coupler 5 may comprise the main path 10, a coupling path 52, the port 70, and the port 90. The difference between the directional coupler 5 and the directional coupler 1 lies in the outline of the coupling path 52 and that of the coupling path 20, wherein the coupling path 52 has a running track outline. Specifically, the coupling path 52 may comprise a first end T1 coupled to the port 70, a second end T2 coupled to the port 90, and at least one winding routed between the first end T1 and the second end T2. Similarly, taking the innermost winding 31 as an example, the first section S11 may have a width W5, the second section S21 may have a width W6, and the width W5 may not be equal to the width W6.

In other examples, the coupling path of the directional coupler may have other outlines, such as an elliptical outline.

With a directional coupler described in the above embodiments, the layout area may be reduced and utilized more efficiently, thereby achieving a compact layout configuration of the directional coupler.

Those skilled in the art will readily appreciate that numerous modifications and alterations of the device and method may be made with the teachings of the invention. Accordingly, the above disclosure should be construed as illustrative and not limited.

What is claimed is:

1. A directional coupler, comprising:
a main path, for transmitting a first radio frequency (RF) signal;
a coupling path, at least partially overlapping with the main path, wherein the coupling path comprises a first end, a second end, and at least one winding routed between the first end and the second end;
a first port, coupled to the first end of the coupling path; and
a second port, coupled to the second end of the coupling path, wherein at least one of the first port and the second port is located inside the at least one winding.

2. The directional coupler of claim 1, wherein the first port is located inside the at least one winding, and the second port is located outside the at least one winding.

3. The directional coupler of claim 1, wherein the first port or the second port is one of the followings: a pad, a through-wafer via, or a through silicon via.

4. The directional coupler of claim 1, wherein the first port or the second port is further coupled to at least one of the followings: a bonding wire, a bump, or a grounded terminal.

5. The directional coupler of claim 1, wherein the at least one winding comprises an innermost winding, the innermost winding comprising a first section and a second section, and the first section is closer to the main path than the second section.

6. The directional coupler of claim 5, wherein the first section has a first width, the second section has a second width, and the first width is greater than the second width.

7. The directional coupler of claim 5, wherein the first section of the innermost winding is parallel to the main path.

8. The directional coupler of claim 7, further comprising at least one passive component, located at the first section of the innermost winding, and coupled between the coupling path and the first port.

9. The directional coupler of claim 8, wherein the at least one passive component comprises a resistor, a first end of the resistor is located at the first section of the innermost winding, and a second end of the resistor is coupled to the first port.

10. The directional coupler of claim 9, wherein the at least one passive component further comprises a capacitor, a first end of the capacitor is located at the first section of the innermost winding, and a second end of the capacitor is coupled to the first port.

11. The directional coupler of claim 5, wherein in a top view of the directional coupler, the first section of the innermost winding overlaps with the main path, and the second section of the innermost winding does not overlap with the main path.

12. The directional coupler of claim 1, wherein the at least one winding comprises an outermost winding, the outermost winding comprising a first section and a second section, and the first section is closer to the main path than the second section.

13. The directional coupler of claim 12, wherein the first section of the outermost winding is parallel to the main path.

14. The directional coupler of claim 13, wherein the second port is located at the second section of the outermost winding.

15. The directional coupler of claim 12, wherein in a top view of the directional coupler, the first section of the outermost winding overlaps with the main path, and the second section of the outermost winding does not overlap with the main path.

16. The directional coupler of claim 1, wherein the main path is formed in a first layer, and the coupling path is formed in a second layer different from the first layer.

17. The directional coupler of claim 16, wherein an insulating layer is formed between the first layer and the second layer.

18. The directional coupler of claim 1, wherein the coupling path has a polygonal outline.

19. A directional coupler, comprising:
a main path, for transmitting a first radio frequency (RF) signal;
a coupling path, at least partially overlapping with the main path, wherein the coupling path comprises a first end, a second end, and at least one winding routed between the first end and the second end, the at least one winding comprises an innermost winding, the innermost winding comprises a first section and a second section, the first section is closer to the main path than the second section, and the first section of the innermost winding is parallel to the main path;
a first port, coupled to the first end of the coupling path;
a second port, coupled to the second end of the coupling path; and
at least one passive component, located at the first section of the innermost winding.

20. The directional coupler of claim 19, wherein the first port is located inside the at least one winding of the coupling path, and the second port is located outside the at least one winding of the coupling path.
